(19) United States
(12) Patent Application Publication
(10) Pub. No.: US 2004/0032733 A1
(43) Pub. Date: Feb. 19, 2004

(54) Candle carrier for use with candle accessories burning tea light candles

(76) Inventors: Frederick V. Gabriel, Eastham, MA (US); Rodney Hass, North Samrong (TH)

Correspondence Address: CHARLES G. CALL, 68 HORSE POND ROAD, WEST YARMOUTH, MA, 02673-2516, US

(21) Appl. No.: 10/636,041

(22) Filed: Aug. 7, 2003

Related U.S. Application Data
(60) Provisional application No. 60/401,929, filed on Aug. 8, 2002.

(51) Int. Cl. F21L 19/00; F21V 35/00

(52) U.S. Cl. 362/161; 362/163

(57) ABSTRACT

A candle carrier for use in combination with a scent burner or similar accessory that accepts standard tea light candles and which includes an opening through which the candle and carrier may be inserted. The carrier includes a support tray and a handle, the support tray being sized and shaped to receive and securely hold a standard tea light candle and the handle being sized and shaped to be easily grasped by the fingers to that the holder and candle can be inserted into and withdrawn from a candle accessory, such as a scent burner.

### CROSS REFERENCE TO RELATED APPLICATIONS

This application is a Non-Provisional of U.S. Patent Application Serial No. 60/401,929 filed Aug. 8, 2003

### FIELD OF THE INVENTION

This invention relates to accessories for use with candles.

### BACKGROUND OF THE INVENTION

Tea light candles are widely used with decorative holders, lamps, scent burners and the like which partially enclose the candle, isolating the flame from persons and nearby articles for enhanced safety, and helping prevent the flame from being extinguished by air drafts. The tea candle itself typically consists of a metallic or plastic container which holds the candle wax, allowing it to liquefy without spilling.

Movement of the candle poses a risk to the user because, when the candle is heated, the liquefied wax retains heat for a prolonged period after it is extinguished. When an attempt is made to remove the candle from the accessory in which it is mounted by hand, the user may burn his or her fingers, causing pain and/or injury.

### SUMMARY OF THE INVENTION

The present invention takes the form of a tea light candle carrier and the method for using the carrier to prevent injury that might otherwise occur when an attempt is made to remove a hot candle from a candle accessory, such as a scent burner or lamp

As contemplated by the invention, in order to more safely replace a tea light candle in a candle accessory, a candle carrier is provided that consists of a tray that forms a receptacle sized to receive an hold a tea light candle, and a handle extending outwardly from the receptacle. A replaceable tea light candle is placed in the carrier tray and the carrier and candle is inserted into the candle accessory by manually grasping the handle. Thereafter, the carrier and candle are removed from the accessory by manually grasping the handle and removing the carrier and candle from the accessory. The method eliminates the need to touch the candle itself during removal and thereby protects the user against being burned when the candle is still hot.

The candle carrier consists of a candle receptacle and a handle attached to and extending outwardly from the receptacle. The receptacle is sized to receive and laterally support a standard tea light candle and the outwardly extending handle is shaped so that it can be easily grasped and held by hand as the candle and tray are inserted into and removed from the candle accessory.

The carrier is preferably formed into a unitary molded shape from a non-flammable material that does not readily conduct heat, such as a molded ceramic, preferably glazed to facilitate cleaning.

These and other features and advantages of the invention may be more clearly understood by considering the following detailed description and the accompanying drawings.

### BRIEF DESCRIPTION OF THE DRAWINGS

FIG. 1 is a perspective view of a candle transport carrier and a scent burner which receives and houses the carrier and candle, and

FIG. 2 is a close-up view of the candle carrier.

### DETAILED DESCRIPTION

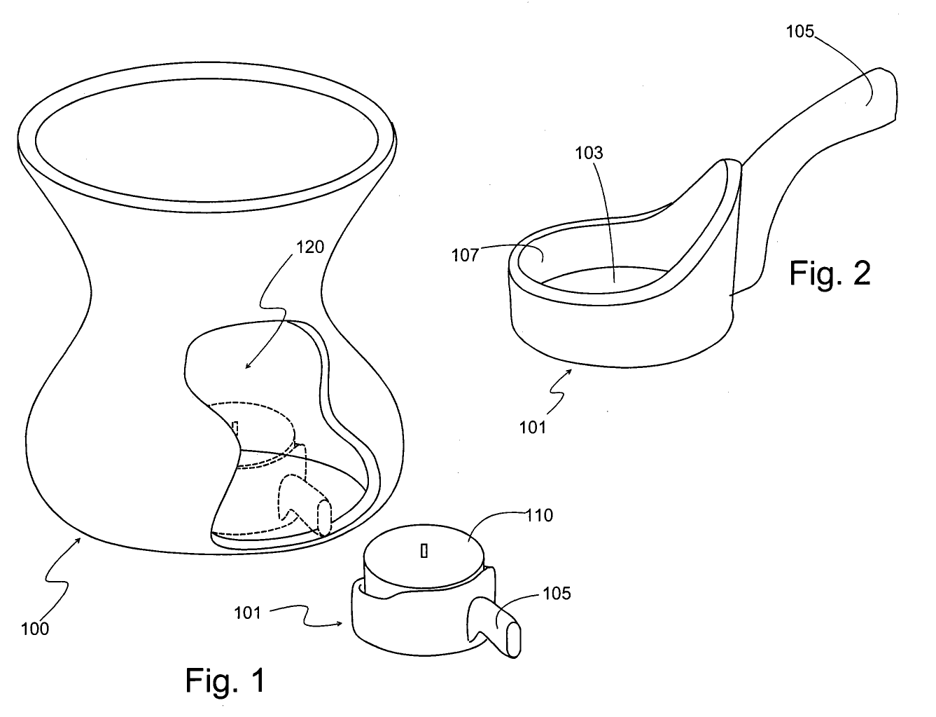

In order to more safely remove a tea light candle from an accessory, such as a scent burner indicated generally at 100 in FIG. 1, or a tea lamp or other candle burning accessory that accepts standard tea light candles. The present invention utilizes a candle carrier indicated generally at 101, a transport device called a “Safety-T-Spoon,” that may be used to easily insert standard tea light candle into the accessory and safely remove the candle from the accessory, even when it is hot.

As shown in the drawings, the Safety-T-Spoon carrier 101 consists of a candle support tray 103 to which an outwardly and upwardly extending handle 105 is attached. The support tray 103 has a circular “floor” that has a diameter slightly larger than the 1.5 inch outside diameter of a standard tea light candle 110 as shown in FIG. 2. A raised rim 107 around the periphery of the circular tray 103 forms a well which receives and retains the tea light candle 110. The distal end of the handle 105 is shaped to form a vertically oriented flange. The lateral sides of the outer flange portion of the handle 105 may be easily grasped by the fingers to maintain the horizontal orientation of the floor of the tray 103 to support the candle 110 as the tray and candle are moved in and out of a candle accessory such as the scent burner seen at 100 in FIG. 1.

The candle carrier 101 is preferably formed as a unitary shaped piece of ceramic or other suitable material which is both sturdy and heat resistant and conducts heat poorly. The outer surface of the carrier is preferably covered with a glaze or enamel to provide a smooth, glossy, easy-to-clean surface to which candle wax does not readily adhere. The candle carrier is particularly suited for use in combination with a scent burner, tea lamp or similar accessory which includes an opening 120 through which the candle and holder are inserted as shown in FIG. 2. The candle carrier may be marketed with the accessory, or sold separately for use with one or more existing accessories.

### CONCLUSION

It is to be understood that the methods and apparatus which have been described above are merely illustrative applications of the principles of the invention. Numerous modifications may be made by those skilled in the are without departing from the true spirit and scope of the invention.

What is claimed is:

1. A candle carrier for use with a candle illuminated accessory comprising, in combination, a candle support tray and a handle attached to and extending outwardly from said tray, said tray being sized to receive and laterally support a standard tea light candle and said handle being sized and shaped to be grasped and held by a human hand.

2. A candle carrier for use with a candle illuminated accessory as set forth in claim 1 wherein said candle carrier is formed from an non-flammable material.

3. A candle carrier for use with a candle illuminated accessory as set forth in claim 2 wherein said material is a ceramic.

4. A candle carrier for use with a candle illuminated accessory as set forth in claim 1 wheerin said support tray consists of a substantially planar circular bottom member having a diameter slightly larger than 1.5 inches for supporting said tea light candle.

5. A candle carrier for use with a candle illuminated accessory as set forth in claim 4 further including a one or more elevated members extending upwardly from the periphery of said bottom member to retain said tea light candle against lateral sliding movement.

6. A scent burner adapted to be heated by a replaceable tealight candle comprising
a candle housing for supporting a scent receptacle, said housing including an sidewall having an opening therein through which a candle may be inserted and removed, and
a candle carrier comprising a substantially planar support member for receiving and retaining a tea light candle and a handle extending outwardly from said support member, said support member and a candle mounted thereon being manually insertable through said opening using said handle.

7. An scent burner adapted to be heated by a replaceable tea light candle as set forth in claim 6 wherein the outer, distal end of said handle is a flange-shaped member providing opposing vertically oriented surfaces which may be grasped by the fingers during transit.

8. An scent burner adapted to be heated by a replaceable tealight candle as set forth in claim 7 wherein said candle housing is also formed from a molded ceramic material.

9. The method of safely replacing a tea light candle in a candle accessory comprising, in combination, the steps of:
providing a candle carrier consisting of a substantially planar bottom member, a handle extending outwardly from said bottom member and one or more raised candle retaining members at the periphery of said bottom member, said candle carrier being sized to receive and support a standard tea light candle placed on said bottom member inside said retaining members,
manually grasping said handle to move said candle carrier and said candle into said candle accessory, and
thereafter removing said candle carrier and candle from said candle accessory by manually grasping said handle.

10. The method of safely replacing a tea light candle in a candle accessory as set forth in claim 9 wherein said candle accessory is a scent burner.

11. The method of safely replacing a tea light candle in a candle accessory as set forth in claim 9 wherein said candle accessory is a tea lamp.
